(19) United States
(12) Patent Application Publication
(10) Pub. No.: US 2020/0310526 A1
(43) Pub. Date: Oct. 1, 2020

(54) SYSTEMS AND METHODS FOR MANAGING POWER CONSUMPTION AND DEVICE RESOURCES

(71) Applicant: KYOCERA Document Solutions Inc., Osaka (JP)

(72) Inventor: Eric de BEUS, Redondo Beach, CA (US)

(73) Assignee: KYOCERA Document Solutions Inc., Osaka (JP)

(21) Appl. No.: 16/365,544

(22) Filed: Mar. 26, 2019

(51) Int. Cl. G06F 1/3296; G06N 5/02

(52) U.S. Cl. CPC G06F 1/3296; G06N 5/02

(57) ABSTRACT

Described herein are systems and methods that intelligently and efficiently manage resources and down-time when operating devices such as networked printers that are capable of reducing power to save energy. The present disclosure provides for creating and using a user model that uses device and user information that has been collected, in part, by monitoring sensors. The model is used to predict a future device usage facilitates toggling between a power-up mode and a power-save mode based on that prediction such as to effectively reduce power consumption and reduce overall device down-time.

### BACKGROUND

### A. Technical Field

The present disclosure relates generally to electronic systems, devices, and methods for intelligent resource and warm-up time management. More particularly, the present disclosure relates to efficiently managing resources, including energy, when operating devices such as networked printers.

### B. Background

Some devices such as office equipment (most printers, copiers, etc.) are equipped with a power-saving feature that at times when the device is not being actively used lower or cut off power supplied to at least some parts of the device. For example, in a printer, power to a fuser may be lowered so as to lower the fuser temperature, a device display may be dimmed or turned off, etc., for the purpose of conserving energy during a standby mode. Although such features typically aid in lowering overall energy consumption, some come at the expense of unproductive time for the user who has to wait for the device to undergo some time-consuming warm-up routine during which the device practically remains inoperable for its intended purpose until all necessary preparations have been completed.

In addition to the limited usability and a slower response time, unnecessarily frequent warm-up cycles that occur sooner than necessary may have the undesired effect of reducing the durability and, thus, the expected lifetime of the device and its components. In scenarios when an existing device, such as a printer, is about to be used at high capacity, it oftentimes may run low on resources, such as toner and paper, and require service or maintenance at seemingly random and unpredictable times. This causes further delays and temporary interruptions that negatively impact both convenience of use and productivity of, e.g., an otherwise high-speed printer.

Accordingly, what is needed are smart systems and methods that overcome the shortcomings of conventional devices and their modes of operation.

### SUMMARY

Various embodiments of the present disclosure comprise a method for training a user model for managing power consumption and device resources. The method may comprise obtaining usage data and resource usage data generated by sensors that monitor a device usage for a device; associating the device usage with a set of users; inputting the usage data into a user model; comparing the device usage to a device usage likelihood to determine an error; using the error to generate an updated user model; iterating until the error satisfies a stop condition; and outputting a trained user model that may comprise a recurrent neural network.

In certain embodiments, the user model may determine a device usage likelihood associated with the set of users and, based on the device usage likelihood satisfying a condition, initiate a power-down event to conserve energy by one or more parts of the device. Based on the device usage likelihood satisfying a second condition, the user model may initiate a power-up event to perform an action by one or more parts to reduce down-time. The usage data may comprise historical resource usage data and historical device usage data, which may further comprise a condition of a consumable resource or a print frequency and a resource usage amount associated with one or more users.

In embodiments, based on the device usage likelihood, a forecast may be generated that predicts a time at which a device resource falls below a predetermined threshold. Based on the forecast, a notification may be generated. Performing the action may comprise performing a printing operation, wherein the power-up event comprises increasing a temperature of a printer fuser or determining a duration for the action. Using the error may comprise feeding it into the user model to generate an updated user model. The user model may assign to two or more users from the set of users different priorities and may approximate an unknown and non-linear data transformation function. Device usage likelihood may be associated with a time of usage or a length of usage. Embodiments may further comprise communicating to a network device an availability of the device or a state of the device.

In embodiments, a system for managing power consumption and device resources may comprise a processor and a non-transitory computer-readable medium comprising instructions that, when executed by the processor, cause steps to be performed, the steps comprising obtaining usage data generated by one or more sensors that monitor a device usage for a device; inputting the usage data into a trained user model to obtain a device usage likelihood associated with a set of users; and based on the device usage likelihood satisfying a condition, initiating a power-up event that comprises, e.g., increasing a temperature of a printer fuser, by at least one or more parts of the device to reduce a down-time. Usage data may comprise resource usage data, historical device usage data, and historical resource usage data that comprises a condition of a consumable resource.

Various embodiments comprise a method that comprises obtaining usage data generated by sensors that monitor a device usage for a device; inputting the usage data into a trained user model to obtain a device usage likelihood associated with a set of users; and based on the device usage likelihood satisfying a condition, initiating a power-down event by one or more parts of the device to reduce a down-time.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments. Items in the figures are not to scale.

FIG. 1 is a flowchart of an illustrative process for device warm-up and resource management according to various embodiments of the present disclosure.

FIG. 2 is a block diagram of a system implementation of the exemplary process for device warm-up and resource management illustrated in FIG. 1, according to various embodiments of the present disclosure.

FIG. 3 depicts a simplified block diagram of a computing device/information handling system, in accordance with embodiments of the present disclosure.

### DETAILED DESCRIPTION OF EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method on a tangible computer-readable medium.

Components, or modules, shown in diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated.

The terms “include,” “including,” “comprise,” and “comprising” shall be understood to be open terms and any lists the follow are examples and not meant to be limited to the listed items. Any headings used herein are for organizational purposes only and shall not be used to limit the scope of the description or the claims. Each reference mentioned in this patent document is incorporate by reference herein in its entirety.

Furthermore, one skilled in the art shall recognize that: (1) certain steps may optionally be performed; (2) steps may not be limited to the specific order set forth herein; (3) certain steps may be performed in different orders; and (4) certain steps may be done concurrently.

In this document the terms “printer” and “printing device” are used interchangeably. Similarly, the terms “usage probability” and “resource usage probability” are used interchangeably.

It shall be noted that although embodiments described herein are presented in the context of printing devices, one skilled in the art shall recognize that the teachings of the present disclosure are not limited to such applications or devices and may equally be used in other contexts, such as consumer electronic devices or other devices that involve a start-up or warm-up time.

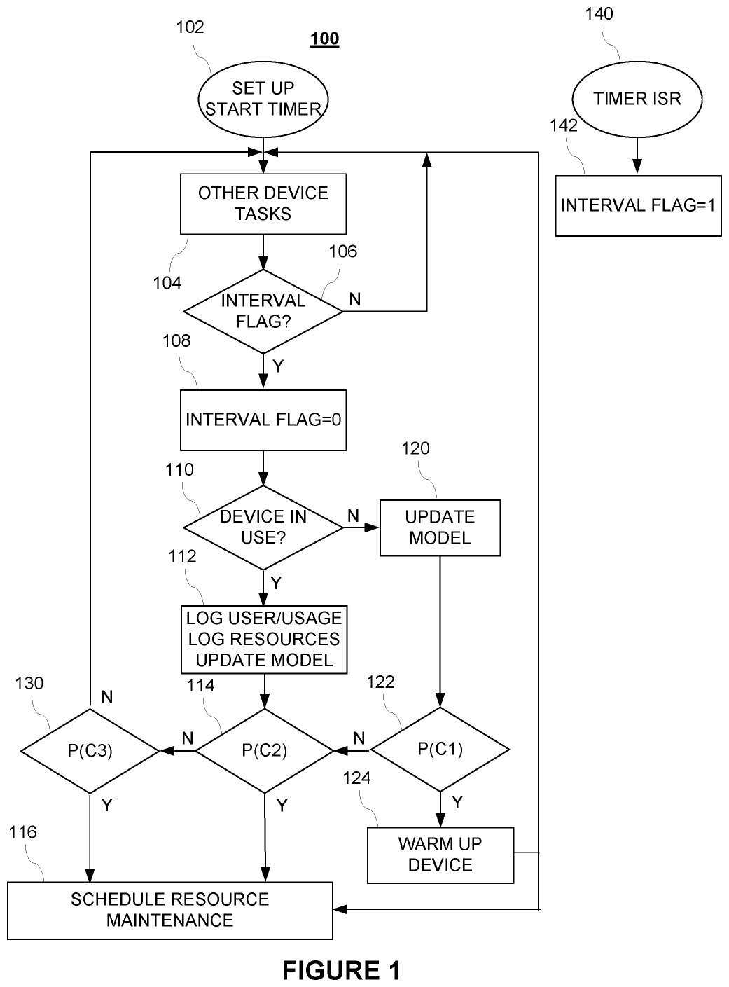

FIG. 1 is a flowchart of an illustrative process for device warm-up and resource management to save energy in accordance with various embodiments of the present disclosure. Process 100 starts at step 102 when, in embodiments, a timer is set for a device, such as a printing device, a copier, etc.

At step 104, one or more device tasks, such as tasks that are not directly related to device warm-up or resource management, may be invoked.

At step 106, it is determined whether an interval flag has been set, e.g., by an interrupt service routine timer. If no interval flag has been set, process 100 may return to step 104; otherwise, process 100 may resume with step 108, at which the interval flag may be reset, e.g., to a zero value.

At step 110, it may be determined whether, in the current time interval, the device is currently in use, i.e., that the device is preparing for a task or is actively engaged in such task. If so, at step 112, a data storage may be updated to indicate a user, the nature of a usage, resources that may be required, etc. In addition, a usage probability model may be updated or adjusted to increase a likelihood that the device is in use for that time interval.

Conversely, if at step 110 it is determined that the device is not in use, then process 100 may continue with step 120, at which the probability model may be adjusted to decrease the likelihood that the device is in use for the time interval.

At step 122, it may be determined whether a probability (denoted as “P(C1)” in FIG. 1) satisfies a predetermined threshold such that, based on the model, the device is likely to be in use in a time interval between the current time and the current time plus the amount of time required to warm up or otherwise prepare the device for use. If the threshold is met, at step 124, a device warm-up procedure may be initiated. On the other hand, if at step 122 it is determined that probability P(C1) does not satisfy the threshold, process 100 may resume with step 114.

At step 114, it is determined whether the probability (denoted as “P(C2)”) satisfies a predetermined threshold such that, based on the model, the sum of expected resource usage within a preset time from the current time may exceed the loaded resources; or the probability that the sum of a typical resource usage by a number of users expected within a preset time from the current time will exceed the loaded resources, then process 100 may continue with step 116.

In embodiments, at step 116, a resource maintenance operation may be scheduled. Process 100 may generate and send notification to an operator of the device or to a management information system that the device is likely to require resources within a preset time period and the type of such resources.

If, at step 114, the threshold for probability P(C2) is not met, process 100 may continue with step 130.

At step 130, it may be determined whether a probability (denoted as “P(C3)”) satisfies a predetermined threshold such that, based on the model, there will likely be no resources required within a time from the current time, but there may be some significant usage after the expiration of a given time period that is prior to an upcoming scheduled resource maintenance.

In embodiments, if the threshold for probability P(C3) is satisfied, process 100 continues with step 116; otherwise, process 100 returns to step 104 to resume with other or additional device tasks that may be performed.

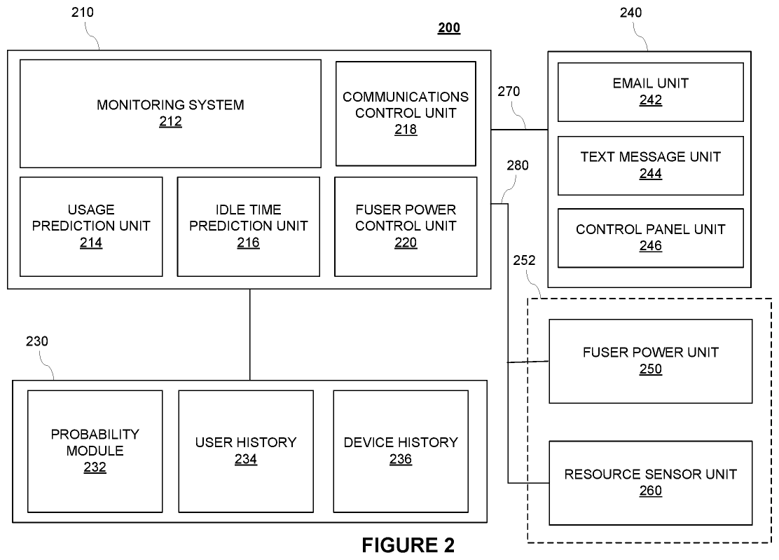

FIG. 2 is a block diagram of a system implementation of the exemplary process for device warm-up and resource management illustrated in FIG. 1, according to various embodiments of the present disclosure. System 200 comprises processing unit 210, memory 230, communications unit 240, fuser power unit 250, and resource sensing unit 260.

Processing unit 210 may comprise monitoring system 212, usage prediction unit 214, idle time prediction unit 216, communications control unit 218, fuser power control unit 220, and resource sensing unit 260 that each may comprise any number of sensors to monitor device resources (e.g., toner, paper, etc.) and operating conditions (e.g., power, lifetime, etc.) in printing device 252, e.g., by using one or more reference timers, counting a cumulative number of successful executions of a printing command, or any other known method known in the art.

In embodiments, processing unit 210 further comprises memory 230 that stores probability model 232 and logs of user history 234 and device history 236, e.g., in records that are arranged in a tabular format so as to be easily accessible and searchable, e.g., by frequency, date, time, resources used, idle time, and the like.

In operation, monitoring system 212 may obtain data from resource sensing unit 260 that monitors and records the status of resources, such as the number of sheets that a toner used in printing device 252 may be able to print before the toner reaches a state at which the toner should be replaced, e.g., to maintain consistent performance.

In addition, monitoring system 212 may monitor and record usage data of printing device 252. It is understood that both active and non-active usage data may be monitored and recorded. It is further understood that gathered data may comprise raw or processed data related to the usage of device resources (e.g., consumables, such as remaining toner and paper levels), timing information (e.g., printing times and operation frequencies relative to other printers in a network), personal/device identification information (e.g., device IP addresses), and status information (e.g., online/offline status).

In embodiments, processing unit 210 may use data obtained by monitoring system 212 to improve detection accuracy of sensor data, e.g., by synchronizing detection times of individual sensors. Resource sensing unit 260, which also may be embedded in printing device 252, may comprise any number of sensors that monitor device resources in printing device 252. Suitable sensors include counters and other types of sensors that have same or similar functions, e.g., optical or capacitive sensors that detect toner levels, weight sensors, differential pressure sensors, liquid level sensors that detect ink levels, and optical or mechanical sensors that detect paper resource levels. In addition to monitoring device resources, resource sensing unit 260 may monitor different quantitative or qualitative measures that may aid in determining short-term and long-term device capacity, such as device or component lifetime.

In embodiments, idle time prediction unit 216, which may be implemented as a separate and distinct unit, may be used to forecast periods of times at which device 252 is expected to not use at least some resources, for example, during certain nighttime hours and periods during operating hours when a certain amount of idle time is expected, such that resources can be refilled without interrupting usage.

In embodiments, resource usage prediction unit 214 may use resource usage data that has been gathered by monitoring system 212 and, based on a number of conditions, predict a future resource usage, such as resource usage amounts attributable to an individual user or group of users, for example, to determine an average resource utilization. In embodiment, resource usage prediction unit 214 may predict a future resource usage by analyzing device usage by users and generating probability model 232 of usage, which may be updated over time.

In embodiments, resource usage prediction unit 214 analyzes device usage by a bounded set of users of a private device, e.g., in an office environment, and generates individual usage probability models for individual users. However, it is understood that this is not intended as a limitation on the scope of the present disclosure, since in embodiments, resource usage prediction unit 214 may analyze device usage, e.g., by an unbounded set of users of a public device in a mobile hot spot, and develop a probability model for user arrivals. It is further understood that embodiments of the present disclosure may equally be applied to other, i.e., non-printing devices, such as consumer electronic devices, toaster ovens, coffee machines, etc, that utilize a power saving feature, such as a standby mode.

In embodiments, resource usage prediction unit 214 may generate usage probability model 232 in response to analyzing monitored device usage data that have been logged during predetermined time intervals, e.g., throughout time periods that a given device is available for use. In embodiments, the monitored usage data may be accumulated and used to constantly refine usage probability model 232 to more accurately predict that the device will be used within a given time interval. For example, probability model 232 may be refined, globally and/or on a per-user basis, depending on whether a device has, in fact, been used at a time when it was powered up. In an environment with a consistent set of users, device usage may be logged on a per user basis and may comprise information about average resources consumed per usage, for example, the amount of paper used by a particular user's print job. Processing unit 210 may store probability model 232, user history 234 and device history 236, which may include respective user and device identifying information, in memory 230, which may be implemented as distributed memory.

In embodiments, probability model 232 may comprise a digital probability distribution function that is generated by accumulating and continually normalizing sampled data. In embodiments, probability model 232 may comprise the use of a neural network, such as a recurrent neural network or any other machine learning model that may be trained to recognize patterns in input data. The network may consist of multiple layers of artificial, i.e., computer-simulated, “neurons,” that are connected to each other by numerically valued artificial “synapses.” Model 232 may be trained using a set of training data, e.g., input data that corresponds to known output data, and have the numerical values of its synapses continually adjusted, e.g., by comparing its output to the desired output, until model 232 can perform a transformation with some acceptable probability of success, e.g., within a predetermined margin of error. In effect, training may produce a model that approximates an unknown and non-linear data transformation function. A recurrent neural network is a neural network in which the output depends not only on the current input but also on previous input, such that the pattern that the network is trained to recognize may include a sequence in time.

In embodiments, communications unit 240 may receive, e.g., from communications control unit 218, data regarding printing device 252 and communicate via a wired 270, 280 or a wireless connection through a wireless network (not shown in FIG. 2), for example, availability, maintenance status, or an operating condition of printing device 252 to a user, e.g., via email 242, text message 244, and/or control panel 246. For example, for a public device in a mobile hot spot, once printing device 252 is warmed up, it may broadcast to mobile device users, using any wireless protocol known in the art, that the printing device is ready for immediate use.

In embodiments, communications unit 240 may orchestrate communication between any number of client and server devices that may be configured to communicate over, e.g., a local area network or the Internet. It is understood that each printing device 252, or a dedicated computing device, may act as a host apparatus. It is further understood that any number of printing devices 252 may communicate with each other and may be synchronized to work together to perform a common task. In embodiments, a user may use communications unit 240 to modify, e.g., manually override, a function or command, e.g., to adjust a status of printing device 252. In embodiments, in circumstances where one or more users have been assigned a priority, printing device 252 might power up, e.g., when usage by a high-priority user is expected at a lower probability threshold than for a relatively lower-priority user.

In embodiments, based on the predicted device resource usage and/or times, an operator of printing device 252 may be prompted to refill certain trays during predicted low-usage times or prior to predicted high-usage times. In embodiments, based on the state of monitored device resources, printing device 252 may produce requests for maintenance, e.g., via email, text message, a notification on a control panel 246 of printing device 252, or some other method, e.g., in response to probability model 232 determining that a given resource level has fallen below a certain threshold thus indicating that device usage is soon to be expected.

In embodiments, for example in circumstances where per-user usage probability data is collected, a request for maintenance may specify an exact amount of resources that are expected to be needed. In embodiments, when priorities are associated with users, a request might be marked urgent, e.g., when usage by a user having a relatively high priority is expected or predicted by probability model 232.

Conversely, when a calculated priority is relatively low, the number of printed sheets per print event may be increased by printing low priority tasks in batches, which advantageously, further reduces power consumption and prolongs device lifetime.

In embodiments, based on the predicted resource usage and/or times, fuser power control unit 220 may cause fuser power unit 250, which may be implemented in printing device 252, to be automatically activated or remain idle based on one or more conditions. Once resource usage prediction unit 214 determines that the printer 252 is likely to be used within a predetermined time period fuser power unit 250 may be warmed up in preparation for a printing operation. For example, in embodiments, fuser power unit 250 may be a heater element that directly or indirectly heats one or more parts of printing device 252 when a probability of arrival of a user within a warm-up time exceeds a predetermined threshold. Advantageously, this targeted and timed fuse activation reduces the time to assume a power-on state and also reduces the amount of power consumption that would otherwise be required to operate printing device 252.

It is noted that system 200 illustrated in FIG. 2 is not limited to the details shown therein or described in the above text. As those skilled in the art will appreciate, a suitable system may comprise a different number of components to accomplish the goals of the present disclosure.

In embodiments, aspects of the present patent document may be directed to, may include, or may be implemented on one or more information handling systems/computing systems. A computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data. For example, a computing system may be or may include a personal computer (e.g., laptop), tablet computer, phablet, personal digital assistant (PDA), smart phone, smart watch, smart package, server (e.g., blade server or rack server), a network storage device, camera, or any other suitable device and may vary in size, shape, performance, functionality, and price. The computing system may include random access memory (RAM), one or more processing resources such as a central processing unit (CPU) or hardware or software control logic, ROM, and/or other types of memory. Additional components of the computing system may include one or more disk drives, one or more network ports for communicating with external devices as well as various input and output (I/O) devices, such as a keyboard, a mouse, touchscreen and/or a video display. The computing system may also include one or more buses operable to transmit communications between the various hardware components.

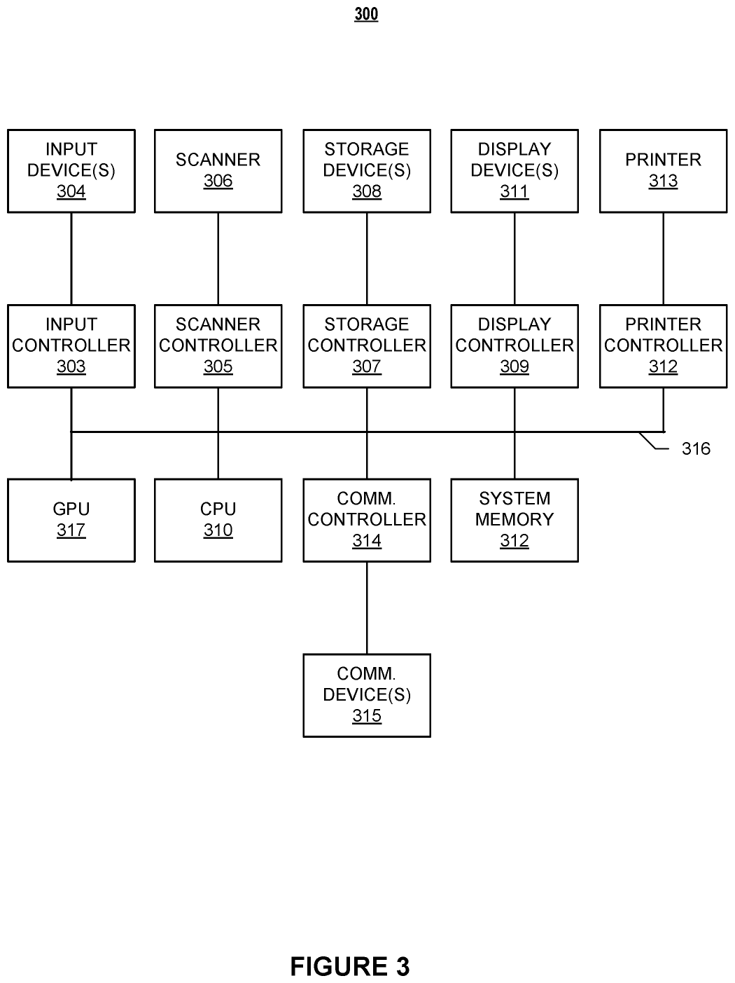

FIG. 3 depicts a simplified block diagram of a computing device/information handling system, in accordance with embodiments of the present disclosure. It will be understood that the functionalities shown for system 300 may operate to support various embodiments of a computing system—although it shall be understood that a computing system may be differently configured and include different components, including having fewer or more components as depicted in FIG. 3.

As illustrated in FIG. 3, the computing system 300 comprises one or more central processing units (CPU) 301 that provides computing resources and controls the computer. CPU 301 may be implemented with a microprocessor or the like, and may also include one or more graphics processing units (GPU) 319 and/or a floating-point coprocessor for mathematical computations. System 300 may also include a system memory 302, which may be in the form of random-access memory (RAM), read-only memory (ROM), or both.

A number of controllers and peripheral devices may also be provided, as shown in FIG. 3. An input controller 303 represents an interface to various input device(s) 304, such as a keyboard, mouse, touchscreen, and/or stylus. The computing system 300 may also include a storage controller 307 for interfacing with one or more storage devices 308 each of which includes a storage medium such as magnetic tape or disk, or an optical medium that might be used to record programs of instructions for operating systems, utilities, and applications, which may include embodiments of programs that implement various aspects of the present invention. Storage device(s) 308 may also be used to store processed data or data to be processed in accordance with the invention. The system 300 may also include a display controller 309 for providing an interface to a display device 311, which may be a cathode ray tube (CRT), a thin film transistor (TFT) display, organic light-emitting diode, electroluminescent panel, plasma panel, or other type of display. The computing system 300 may also include one or more peripheral controllers or interfaces 305 for one or more peripherals 306. Examples of peripherals may include one or more input devices, output devices, sensors, and the like. A communications controller 314 may interface with one or more communication devices 315, which enables the system 300 to connect to remote devices through any of a variety of networks including the Internet, a cloud resource (e.g., an Ethernet cloud, an Fiber Channel over Ethernet (FCoE)/Data Center Bridging (DCB) cloud, etc.), a local area network (LAN), a wide area network (WAN), a storage area network (SAN) or through any suitable electromagnetic carrier signals including infrared signals.

In the illustrated system, all major system components may connect to a bus 316, which may represent more than one physical bus. However, various system components may or may not be in physical proximity to one another. For example, input data and/or output data may be remotely transmitted from one physical location to another. In addition, programs that implement various aspects of the invention may be accessed from a remote location (e.g., a server) over a network. Such data and/or programs may be conveyed through any of a variety of machine-readable medium including, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices.

Aspects of the present invention may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present invention may further relate to computer products with a non-transitory, tangible computer-readable medium that have computer code thereon for performing various computer-implemented operations. The media and computer code may be those specially designed and constructed for the purposes of the present invention, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present invention may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present invention. One skilled in the art will also recognize that a number of the elements described above may be physically and/or functionally separated into sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A method for training a user model for managing power consumption and device resources, the method comprising:
obtaining usage data generated by one or more sensors that monitor a device usage for a device, the usage data comprising resource usage data;
associating the device usage with a set of users;
inputting the usage data into a user model that:
determines a device usage likelihood associated with the set of users;
based on the device usage likelihood satisfying a first condition, initiates a power-down event to conserve energy by the one or more parts of the device; and
based on the device usage likelihood satisfying a second condition, initiates a power-up event to perform an action by at least one or more parts of the device to reduce a down-time;
comparing the device usage to the device usage likelihood to determine an error;
using the error to generate an updated user model;
iterating until the error satisfies a stop condition; and
outputting a trained user model.

2. The method according to claim 1, wherein the usage data comprises historical device usage data and historical resource usage data.

3. The method according to claim 2, wherein the historical device usage data comprises a condition of a consumable resource.

4. The method according to claim 2, wherein the historical resource usage data comprises a print frequency and a resource usage amount associated with one or more users.

5. The method according to claim 1, further comprising, based on the device usage likelihood, generating a forecast that predicts a time at which a device resource falls below a predetermined threshold and, based on the forecast, generating a notification.

6. The method according to claim 1, wherein performing the action comprises performing a printing operation and wherein the power-up event comprises increasing a temperature of a printer fuser.

7. The method according to claim 1, wherein initiating the power-up event comprises determining a duration for the action.

8. The method according to claim 1, wherein using the error comprises feeding the error into the user model to generate the updated user model.

9. The method according to claim 1, wherein the device usage likelihood is associated with a time of usage or a length of usage.

10. The method according to claim 1, further comprising communicating to a network device at least one of an availability of the device or a state of the device.

11. The method according to claim 1, wherein the user model assigns to two or more users from the set of users different priorities.

12. The method according to claim 1, wherein the user model approximates an unknown and non-linear data transformation function.

13. The method according to claim 1, wherein the user model comprises a recurrent neural network.

14. A system for managing power consumption and device resources, the system comprising:
a processor; and
a non-transitory computer-readable medium comprising instructions that, when executed by the processor, cause steps to be performed, the steps comprising:
obtaining usage data generated by one or more sensors that monitor a device usage for a device, the usage data comprising resource usage data;
inputting the usage data into a trained user model to obtain a device usage likelihood associated with a set of users; and
based on the device usage likelihood satisfying a condition, initiating a power-up event by at least one or more parts of the device to reduce a down-time.

15. The system according to claim 14, wherein the usage data comprises historical device usage data and historical resource usage data.

16. The system according to claim 15, wherein the historical device usage data comprises a condition of a consumable resource.

17. The system according to claim 14, wherein the power-up event comprises increasing a temperature of a printer fuser.

18. A method for managing power consumption and device resources, the method comprising:
obtaining usage data generated by one or more sensors that monitor a device usage for a device, the usage data comprising resource usage data;
inputting the usage data into a trained user model to obtain a device usage likelihood associated with a set of users; and
based on the device usage likelihood satisfying a condition, initiating a power-down event by at least one or more parts of the device to reduce a down-time.

19. The method according to claim 18, wherein the usage data comprises historical device usage data and historical resource usage data.

20. The method according to claim 19, wherein the historical device usage data comprises a condition of a consumable resource.
